(19) United States
(12) Patent Application Publication
(10) Pub. No.: US 2025/0069434 A1
(43) Pub. Date: Feb. 27, 2025

(54) DEVICE AND METHOD FOR PROCESSING HUMAN FACE IMAGE DATA

(71) Applicant: UNISSEY, Champs sur Marne (FR)

(72) Inventor: Sheng FENG, Champs sur Marne (FR)

(73) Assignee: UNISSEY, Champs sur Marne (FR)

(21) Appl. No.: 18/722,709

(22) PCT Filed: Dec. 23, 2022
(86) PCT No.: PCT/FR2022/052496

§ 371 Date: Jun. 21, 2024

(30) Foreign Application Priority Data
Dec. 24, 2021 (FR) FR2114494

(51) Int. Cl. G06V 40/16; G06N 3/045; G06N 3/084; G06V 10/82

(52) U.S. Cl. CPC G06V 40/172; G06N 3/045; G06N 3/084; G06V 10/82; G06V 40/168

(57) ABSTRACT

A device for processing human face image data includes an extractor arranged to receive image data and to extract therefrom a set of features, and two or more classifiers arranged to receive a set of features from the extractor and to return a value for classifying or labelling the corresponding image data. The extractor is a deep neural network and the two or more classifiers comprise a single common neural network and one or more neural networks specific to subsets of human face images. The classifiers are trained specifically to detect particular subsets of human face images.

The invention relates to the field of image processing, and in particular to the processing of images of human faces.

Tools based on artificial intelligence are increasingly used for everything relating to image recognition. One could notice this in the field of medical imaging as well as in the field of human presence detection or face recognition.

The development of these tools has followed two main axes.

The first axis relates to the creation of deep neural networks, through the creation of families of models, such as ResNet, DenseNet, MobileNet, ResNext, etc. Each of these families of models brings in its batch of progress and trade-offs and have the main common point of extracting features of images received at the input. Afterwards, these features are used by conventional neural networks, often with whole layers, which are intended to classify the images.

The second axis is the enrichment of the training image bases. Indeed, the computing capabilities allow training deep neural networks with increasingly larger amounts of data. Yet, this poses several problems. Indeed, the training times being very long, it is common to use a pre-trained network, or with a training database already known, in order to be able to reuse model weights or variables in a manner minimising the risk of wasting time at training (because of the risk of non-convergence or of unsatisfactory result). In other words, the training bases are larger, in order to provide better results, but it is difficult to change them. This means that the same base is used to so everything, and that it is sought to compensate for the absence of specialisation downstream.

This specialisation may be useful to better identify faces, for example, or to better distinguish between medical images.

Hence, efforts have been made in order to try to use several distinct training bodies in order to specialise deep neural networks on particular problems, by merging the common and special-purpose bodies. Yet, the problem of the quantitative representation of each body arises. Indeed, when a special-purpose body containing 1,000 times less data than the common body is used with the latter to train a neural network, this special-purpose body has almost no effect on the training. Conversely, if the common body is trained at first, and then it is specialised by carrying out a fine adjustment on the special-purpose body, the risk incurred is an over-specialisation of the neural network on the special-purpose body.

Hence, to date, there is no satisfactory solution for providing a device for processing human images that can take account of specific features.

The invention improves the situation. To this end, it provides a device for processing human face image data comprising an extractor arranged to receive image data and to extract therefrom a set of features, and two or more classifiers arranged to receive a set of features from the extractor and to return a classification or labelling value of the corresponding image data, wherein the extractor is a deep neural network and the two or more classifiers comprise a single common neural network and one or more neural networks specific to subsets of human face images, the subsets of human face images comprising at least one common subset of human face images, and one or more specific subsets of human face images such as the human face image data of a specific subset of human face images have, individually or together, a common human feature and such that two distinct specific subsets do not have a number of identical images greater than 50%, and the common subset comprising a number of images at least 100 times as great as the numbers of images of the specific subsets, the training of the extractor and of the two or more classifiers is carried out:
a) by training the extractor and a first one of the classifiers together using the common subset of human face images,
b) by blocking the training of the extractor and by training another classifier with a first specific subset,
c) by repeating the operation b) each time with another classifier and with a distinct specific subset, until all distinct specific subsets have been used to train a classifier,
d) by carrying out a backpropagation training operation comprising
d1) defining a mixed dataset comprising image data originating from the common subset and each of the specific subsets,
d2) executing the extractor with the mixed dataset, and classifying the resulting sets of features into subsets of sets of features according to the subset from which the image data in the mixed dataset are derived,
d3) executing each classifier with the subset of sets of features corresponding to the subset that has been used in training that classifier in the operation a), b) or c),
d4) calculating for each classifier a loss value from the classification or labelling value originating from the operator d3), and
d5) carrying out a backpropagation from a weighted average of the loss values of the operation d4).

This device is particularly advantageous because it allows, by specific learning, providing a device that uses all the power of the general-purpose training bases while allowing adapting it to the detection of specific features.

According to various embodiments, the invention may have one or more of the following features:
the extractor is a deep neural network adapted for the extraction of image features, like a network of the ResNet family, or a network of the DenseNet, MobileNet, ResNext family,
the extractor is a ResNet-101 deep neural network,
the classifiers are of the ArcFace type,
the device comprises a specific subset of human face images having a wide variety of ages, and
the device comprises a specific subset of human face images having a wide variety of make-ups.

The invention also relates to a method for training a device for processing human face image data comprising an extractor arranged to receive image data and to extract therefrom a set of features, and two or more classifiers arranged to receive a set of features from the extractor and to return a classification or labelling value of the corresponding image data, wherein the extractor is a deep neural network and the two or more classifiers comprise a single common neural network and one or more neural networks specific to subsets of human face images, the subsets of human face images comprising at least one common subset of human face images, and one or more specific subsets of human face images such as the human face image data of a specific subset of human face images have, individually or together, a common human feature and such that two distinct specific subsets do not have a number of identical images greater than 50%, and the common subset comprising a number of images at least 100 times as great as the numbers of images of the specific subsets, wherein the training of the extractor and of the two or more classifiers is carried out:
a) by training the extractor and a first one of the classifiers together using the common subset of human face images,
b) by blocking the training of the extractor and by training another classifier with a first specific subset,
c) by repeating the operation b) each time with another classifier and with a distinct specific subset, until all distinct specific subsets have been used to train a classifier,
d) by carrying out a backpropagation training operation comprising
d1) defining a mixed dataset comprising image data originating from the common subset and each of the specific subsets,
d2) executing the extractor with the mixed dataset, and classifying the resulting sets of features into subsets of sets of features according to the subset from which the image data in the mixed dataset are derived,
d3) executing each classifier with the subset of sets of features corresponding to the subset that has been used in training that classifier in the operation a), b) or c),
d4) calculating for each classifier a loss value from the classification or labelling value originating from the operator d3), and
d5) carrying out a backpropagation from a weighted average of the loss values of the operation d4).

Other features and advantages of the invention will appear more clearly upon reading the following description, derived from examples given for illustrative and non-limiting purposes, from the drawings wherein:

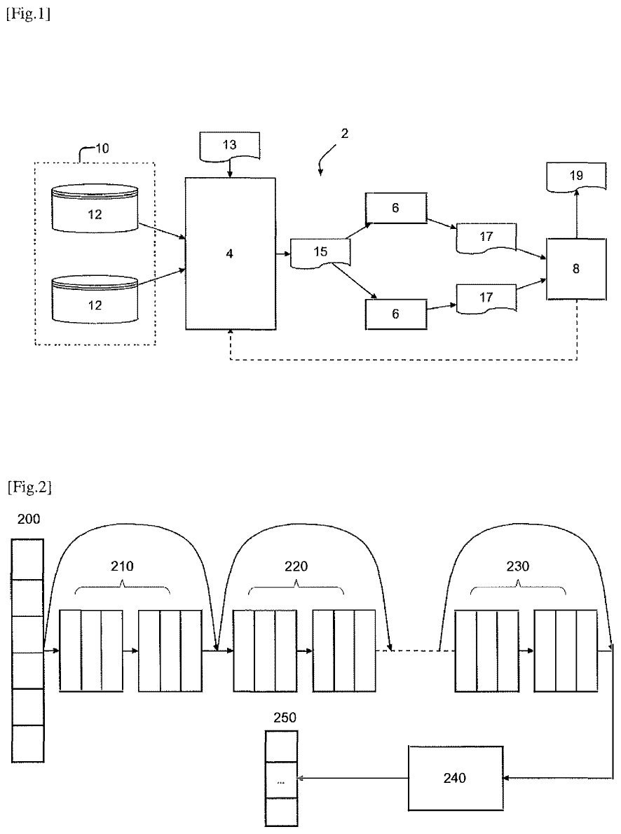

FIG. 1 shows a generic diagram of a device according to the invention,

FIG. 2 shows an example of implementation of the extractor of FIG. 1,

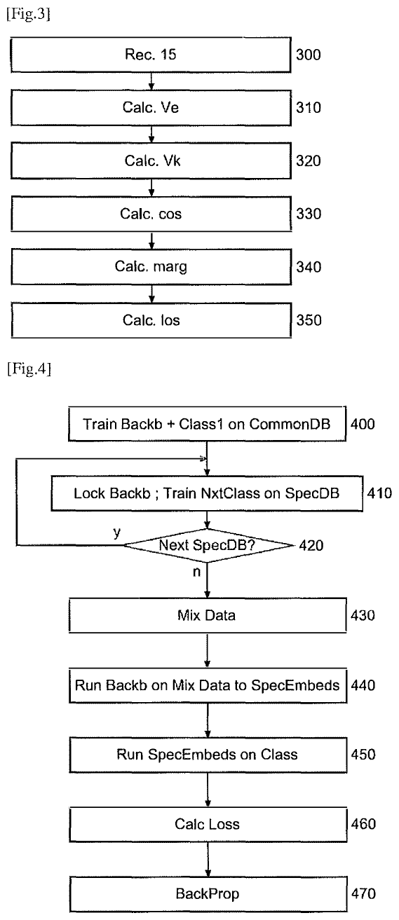

FIG. 3 shows an example of implementation of a classifier of FIG. 1, and

FIG. 4 shows an example of implementation of a training of the device of FIG. 1.

The drawings and the description hereinafter essentially contain elements of a certain nature. Hence, they can not only be used to better understand the present invention, but also contribute to the definition thereof, where appropriate.

FIG. 1 shows a generic diagram of an image processing device 2 according to the invention.

In the example described herein, the images are images wherein the useful information is formed by faces, and the device 2 may be used to carry out facial recognition. Alternatively, the images could consist of images obtained by imaging, for example by CT, scan, or MRI, or consist of photos of a portion of a human body, for example including a beauty spot.

As will be seen hereinbelow, the device 2 allows training several neural networks which could be both general-purpose and special-purpose. In general, it is important that the images used to carry out the training of these neural networks are consistent with one another, i.e. they have a significant useful portion in common. Thus, if the images are faces, some could contain the neck, the hair, and an environment. Yet, most of them will have to be framed or reworked to represent mostly a face and not several ones or a portion that is too large of the rest of the body.

In the example described herein, the device 2 comprises an extractor 4, three classifiers 6, and a unifier 8. As explained hereinabove, the aim is to offer a device 2 with excellent general capabilities, but also special-purpose capabilities. For this reason, among the classifiers 6, one is general-purpose, and one is special-purpose. In general, a device 2 according to the invention will always include at least two classifiers: a general-purpose one and at least one special-purpose one. In the case of K classifiers, there will be one general-purpose classifier, and (K−1) special-purpose classifiers.

To train these classifiers, a memory 10 receives as many databases 12 as classifiers 6. These are these databases 12 which, by their specific content, will allow specialising some of the classifiers. Thus, if there are K classifiers 6, then there are K databases 12, one of which is so-called general-purpose and will generally contain an enormous amount of images, and (K−1) are specific with an amount of images much smaller than that of the general-purpose database.

In the example described herein, the general-purpose database may be the database Glint360k (for example accessible at the address https://web.archive.org/web/20201120191720/https://github.com/deepinsight/insightfac e/tree/master/recognition/partial_fc#Glint360k) contains about 17 million face images.

In the example described herein, one of the special-purpose databases is the database AgeDB (for example accessible the address at https://ibug.doc.ic.ac.uk/resources/agedb/), which contains 16,488 images.

Hereafter, an example allowing demonstrating the advantages of the device 2 will use the database CALFW (for example accessible at the address https://web.archive.org/web/20210923094739/http://www.w hdeng.cn/CALFW), which contains about 6,000 pairs of images.

An important element of the specific databases is that all of the images that they contain have a common human criterion, and this criterion may be specific to each image or defined by several images of the specific database together. For example, a database could be specialised in dermatology on malignant beauty grains for some skin colours. In the case of the AgeDB base, the images together define a homogeneous representation of age allowing better distinguishing between faces of distinct ages, etc. Alternatively, specific bases could be used to specialise the detection on more or less made-up faces, on some types of ethnicities, etc.

The memory 10 may be any type of data storage capable of receiving digital data: hard drive, solid-state drive, flash memory in any form, random-access memory, magnetic disk, a storage distributed locally or in the cloud, etc. The data calculated by the device may be stored on any type of memory similar to the memory 10, or on the latter. These data may be erased after the device has performed its tasks or conserved.

The databases 12 may be of any type, including a directory or several images, and their structure may be explicit or implicit, for example based on the names and/or access paths of the files.

In the example described herein, the extractor 4 is a deep neural network of the ResNet-101 type. The extractor 4 is intended to receive an input image 13, and to derive a set of features 15 therefrom. Afterwards, this set of features 15 is sent to the classifiers 6 which each determine a response value 17, which is sent to the unifier 8 which calculates an output value 19 from the response values 17.

In the example described herein, the resolution of the input images, whether for training or processing, is set (by selection or resizing) at 112*112*3, and the sets of features 15 is a vector of 512 elements.

Alternatively, the extractor 4 could be any type of deep neural network suited to the extraction of image features, like another network of the ResNet family, or a network of the DenseNet, MobileNet, ResNext, etc., family.

In the example described herein, the classifiers 6 are ArcFace neural networks, described in the article by J. Deng, J. Guo, N. Xue and S. Zafeiriou, “ArcFace: Additive Angular Margin Loss for Deep Face Recognition” 2019 IEEE/CVF Conference on Computer Vision and Pattern Recognition (CVPR), 2019, pp. 4685-4694, doi: 10.1109/CVPR.2019.00482

The unifier 8 plays a double role.

In the “runtime” use of the device 2, the unifier 8 receives the outputs of the classifiers 6 to return the output value 19 as explained hereinabove. For this purpose, the unifier 8 carries out a weighting of the outputs. In the example described herein, the weighting values are determined empirically. Alternatively, the unifier 8 could carry out an arithmetic mean, or be a special-purpose neural network in the reconciliation of the outputs of the classifiers 6.

During the training, the unifier 8 is used during a special operation to carry out a backpropagation as will be described hereinbelow. Alternatively, the backpropagation could be carried out by an element distinct from the unifier 8. More specifically, during the training, the unifier 8 weights the results of the cost functions of each of the classifiers 6 to carry out a backpropagation, as described with FIG. 4. In the example described herein, the weight values are determined empirically. Alternatively, the unifier 8 could carry out an arithmetic mean, or be a special-purpose neural network in the reconciliation of the cost functions of classifiers 6.

The extractor 4, the classifiers 6 and the unifier 8 directly or indirectly access the memory 10. They may be made in the form of an appropriate computer code executed on one or more processors. By processors, it should be understood any processor suited to the calculations described hereinbelow. Such a processor may be made in any known manner, in the form of a microprocessor for a personal computer, a dedicated chip of the FPGA or SoC type, a computing resource on a grid or in the cloud, a cluster of graphics processors (GPUs), a microcontroller, or of any other form suited to provide the computing power necessary for the process described hereinbelow. One or more of these elements may also be made in the form of special-purpose electronic circuits such as an ASIC. A combination of a processor and electronic circuits may also be considered. Of course, processors dedicated to machine learning could also be considered.

FIG. 2 shows an example of implementation of the extractor 4.

As explained hereinabove, the extractor 4 is in the example described herein a deep neural network of the ResNet-101 type. The ResNet models have been developed to solve the gradient vanishing problem which is even more acute in deep neural networks that these have a significant depth.

For this purpose, the RestNet model has introduced the concept of residual learning block. Thus, as shown in FIG. 2, the extractor 4 comprises a plurality of learning blocks 210, 220, 230 in which the gradient propagates, and, between consecutive upstream learning block and downstream learning block, the gradient 200 at the input of the upstream learning block is added to the output of the upstream learning block to form the input of the downstream learning block. This is symbolised by the arrows in FIG. 2. This transmission of the gradient enables the backpropagation of the gradients to be stable and considerably reduces the risk of gradient vanishing.

Thus, the learning block 210 comprises two convolution layers 212 and 214, the learning block 220 comprises two convolution layers 222 and 224, and the learning block 230 comprises two convolution layers 232 and 234. The gradient at the output of the block 210 is added to the gradient at the output of the block 220 as an input of the next block, etc.

At the output of the last learning block (herein 230), a fully-connected layer 240

The table hereinbelow represents the compositions of various RestNet models, including the ResNet 101 model of the extractor 4 receives as input the output of the block 230 as well as its gradient as input, and returns the result in an output layer 250. In this case, the output layer 250 contains the set of features 15.

TABLE 1

| | Dimension of | | | | | | | | | | | | |
|---|---|---|---|---|---|---|---|---|---|---|---|---|---|
| Layer | the output | RestNet18 | | | | RestNet34 | | | | RestNet50 | | | |
| Conv1 | 112 × 112 | 7 × 7, 64/3 × 3 Max Pool | | | | | | | | | | | |
| Conv2 | 56 × 56 | | 3 × 3, 64 | | | | 3 × 3, 64 | | | | 1 × 1, 64 | | |
| | | {open oversize bracket} | | {close oversize bracket} | ×2 | {open oversize bracket} | | {close oversize bracket} | ×2 | | | | |
| | | | 3 × 3, 64 | | | | 3 × 3, 64 | | | {open oversize bracket} | 3 × 3, 64 | {close oversize bracket} | ×3 |
| | | | | | | | | | | | 1 × 1, 256 | | |
| Conv3 | 28 × 28 | | 3 × 3, 128 | | | | 3 × 3, 128 | | | | 1 × 1, 128 | | |
| | | {open oversize bracket} | | {close oversize bracket} | ×2 | {open oversize bracket} | | {close oversize bracket} | ×2 | | | | |
| | | | 3 × 3, 128 | | | | 3 × 3, 128 | | | {open oversize bracket} | 3 × 3, 128 | {close oversize bracket} | ×4 |
| | | | | | | | | | | | 1 × 1, 512 | | |
| Conv4 | | | 3 × 3, 64 | | | | 3 × 3, 256 | | | | 1 × 1, 256 | | |
| | | {open oversize bracket} | | {close oversize bracket} | ×2 | {open oversize bracket} | | {close oversize bracket} | ×4 | | | | |
| | | | 3 × 3, 64 | | | | 3 × 3, 256 | | | {open oversize bracket} | 3 × 3, 256 | {close oversize bracket} | ×6 |
| | | | | | | | | | | | 1 × 1, 1024 | | |
| Conv5 | | | 3 × 3, 64 | | | | 3 × 3, 5 | | | | 1 × 1, 512 | | |
| | | {open oversize bracket} | | {close oversize bracket} | ×2 | {open oversize bracket} | | {close oversize bracket} | ×6 | | | | |
| | | | 3 × 3, 64 | | | | 3 × 3, 64 | | | {open oversize bracket} | 3 × 3, 512 | {close oversize bracket} | ×3 |
| | | | | | | | | | | | 1 × 1, 2048 | | |

| | | |
|---|---|---|
| Output | 1 × 1 | Avg. Pool, Fully-connected layer × 1000, softmax |

| | Dimension of | | | | | | | | |
|---|---|---|---|---|---|---|---|---|---|
| Layer | the output | RestNet101 | | | | RestNet151 | | | |
| Conv1 | 112 × 112 | 7 × 7, 64/3 × 3 Max Pool | | | | | | | |
| Conv2 | 56 × 56 | | 1 × 1, 64 | | | | 1 × 1, 64 | | |
| | | {open oversize bracket} | 3 × 3, 64 | {close oversize bracket} | ×3 | {open oversize bracket} | 3 × 3, 64 | {close oversize bracket} | ×3 |
| | | | 1 × 1, 256 | | | | 1 × 1, 256 | | |
| Conv3 | 28 × 28 | | 1 × 1, 128 | | | | 1 × 1, 128 | | |
| | | {open oversize bracket} | 3 × 3, 128 | {close oversize bracket} | ×4 | {open oversize bracket} | 3 × 3, 128 | {close oversize bracket} | ×4 |
| | | | 1 × 1, 512 | | | | 1 × 1, 512 | | |
| Conv4 | | | 1 × 1, 256 | | | | 1 × 1, 256 | | |
| | | {open oversize bracket} | 3 × 3, 256 | {close oversize bracket} | ×23 | {open oversize bracket} | 3 × 3, 256 | {close oversize bracket} | ×36 |
| | | | 1 × 1, 1024 | | | | 1 × 1, 1024 | | |
| Conv5 | | | 1 × 1, 512 | | | | 1 × 1, 512 | | |
| | | {open oversize bracket} | 3 × 3, 512 | {close oversize bracket} | ×3 | {open oversize bracket} | 3 × 3, 512 | {close oversize bracket} | ×3 |
| | | | 1 × 1, 2048 | | | | 1 × 1, 2048 | | |

| | | |
|---|---|---|
| Output | 1 × 1 | Avg. Pool, Fully-connected layer × 1000, softmax |

Thus, there are 5 types of learning blocks, and within one block type, convolutional layers are concatenated with the dimensions indicated in Table 1, wherein “3×3” indicates the size of the convolution kernel, and “64” indicates the depth, etc.

The more learning blocks are, and the more powerful the extractor 4 will be, and the greater the power required to train it will be.

Although the ResNet 101 model has given the best results in the researches of the Applicant, other models may be retained, as explained hereinabove.

FIG. 3 shows an example of implementation of a classifier 6.

The classifier 6 is used to identify faces in the example described herein. A good face comparison model can give a high similarity score to two corresponding samples, while the similarity is low for two non-corresponding samples.

In the example described herein, the classifier 6 is of the Arcface type. Arcface development has been a very important step for comparing faces.

Before Arcface, two main approaches existed for forming a face comparison model.

The first approach is so-called triplet loss. Three images form the triplet in the input data and are respectively named anchor, positive and negative. The objective of the training is to maximise the difference between the similarity between the anchor and the positive sample and the similarity between the anchor and the negative sample. However, it is very complicated to generate these three images for training, and a poor sampling of the three images cannot help form a good model.

The second approach consists in training a face comparison model via a classification training task with a “CrossEntropyLoss” type loss.

However, the classification training task cannot generate a model with a large generalisation capability. In other words, the model may have a very good performance during training, but a poor performance in the test data.

ArcFace has been designed to solve the problem of generalisation. By introducing the concept of angular margin, the model is trained to have a high margin between the classes. In other words, the similarity between the samples of the same class is low and the similarity between the samples of different classes is high.

For this purpose, ArcFace carries out the operations shown in FIG. 3.

In an operation 300, the classifier 6 receives the set of features 15 at the output of the extractor 4. Afterwards, in an operation 310, the set of features 15 is normalised into a vector Ve, then in an operation 320, the kernel is normalised in a layer fully connected to a vector Vk. An operation 330 is then executed to calculate cos(θ)=Ve×Vk, then a margin is added in an operation 340 to obtain cos(θ+margin). Finally, the loss function is calculated in an operation 350 according to the formula

$$- \frac{1}{N} {\sum }_{i = 1}^{N} \frac{{e}^{s ( cos ( {ϑ}_{y i} + m ) )}}{{e}^{s ( cos ( {ϑ}_{y i} + m ) )} + {\sum }_{j = 1 , j \neq y i}^{n} {e}^{s ( cos ( {ϑ}_{j} ) )}}$$

In this formula, N is the number of samples, s is a gain value selected so as to stabilise the backpropagation loss, yi is the truth index, θ_{yi} is the angle between the vector Ve and the class centre vector Vyi, θⱼ is the angle between the vector Ve and the class centre vector Vj, m is the angular margin and n is the number of features.

Alternatively, the classifiers 6 could be other than based on ArcFace and consist of neural networks of the prior art of face detection.

FIG. 4 shows an example of implementation of the training of the device 2 enabling it to obtain general-purpose and special-purpose capabilities.

The general idea is to firstly train the general-purpose portion of the device 2, then separately each special-purpose classifier, then, finally, finely adjust the set by backpropagation.

Thus, in an operation 400, the extractor 4 is trained together with the general-purpose classifier 6 on the general-purpose database 12. This database and the classifier could also be so-called common, because they represent a common knowledge, in contrast with specific databases and classifiers.

The result of this training is an extractor 4 having an image analysis quality and which produces sets of features well suited to the common images. The common classifier is also in a satisfactory training state.

Afterwards, the specific classifiers will be trained in a loop. For this purpose, the extractor 4 is frozen, so that the training of the specific classifiers does not over-train it, and the training of the specific classifiers is carried out in an operation 410. This training is carried out using one of the specific databases. Afterwards, in an operation 420, it is verified whether there remains a specific database that has not yet been used to train a classifier. If so is the case, then he operation 410 is repeated. Otherwise, the loop ends, and all specific classifiers have been trained, each with a specific database. Alternatively, the operations 410 could be carried out in parallel, since the extractor 4 is frozen.

Hence, once this loop has ended, the device 2 comprises an extractor 4 which has been trained with a general-purpose database to carry out the extraction of sets of features of the images and a general-purpose classifier 6, and a specific classifier 6 which has been trained with a specific database.

The function of the following operations is to specialise the device 2 in order to combine the general-purpose and specific forces.

For this purpose, in an operation 430, a global training dataset is generated from the databases 12. This generation is carried out while preserving the identification of the original database 12 of each image.

Afterwards, in an operation 440, the extractor 4 is unblocked in order to be able to carry out a new training, and the global training dataset is supplied to the extractor 4 in order to determine therein the sets of features of the images that it contains.

These sets of features are then sent to each classifier 6, each according to the database 12 from which the corresponding image is drawn. Thus, if an image of the global training dataset is drawn from the general-purpose database, then its set of features will be sent to the common classifier, and if it is drawn from the specific database, then its set of features will be sent to the specific classifier. In the case of several specific databases, the set of features will be sent to each particular specific classifier according to the original database.

Each classifier 6 then determines, for each set of features regarding it, a response value 17 in an operation 450, then in an operation 460, a loss function is executed to determine, for each classifier 6, a loss value of the response values 17 produced thereby. This loss function may be identical for all classifiers, or be distinct.

Finally, in an operation 470, the values derived from the loss function of the classifiers are weighted by the unifier 8 and used to carry out a backpropagation which is reintroduced into the extractor 4.

The device 2 thus trained has been used on the aforementioned database CALFW. To assess its performance, it has been compared on this same database with a model using exclusively the ArcFace neural networks in accordance with the aforementioned article.

The obtained results indicate that the accuracy rate of the conventional neural network is 95.4% (namely 4.6% error), while the device 2 offers an accuracy rate of 96.1% (namely 3.9% error). This improvement is considerable and demonstrates the interest of the device 2.

1. A device for processing human face image data comprising an extractor configured to receive image data and to extract therefrom a set of features, and two or more classifiers configured to receive a set of features from the extractor and to return a classification or labelling value of the corresponding image data, wherein the extractor is a deep neural network and the two or more classifiers comprise a single common neural network and one or more neural networks specific to subsets of human face images, the subsets of human face images comprising at least one common subset of human face images, and one or more specific subsets of human face images such as human face image data of a specific subset of human face images have, individually or together, a common human feature and such that two distinct specific subsets do not have a number of identical images greater than 50%, and the common subset comprising a number of images at least 100 times as great as the numbers of images of the specific subsets, the training of the extractor and of the two or more classifiers being carried out by the following operations:
a) training the extractor and a first one of the classifiers together using the common subset of human face images,
b) blocking the training of the extractor and training another classifier with a first specific subset,
c) repeating the operation b) each time with another classifier and with a distinct specific subset, until all distinct specific subsets have been used to train a classifier,
d) carrying out a backpropagation training operation comprising:
d1) defining a mixed dataset comprising image data originating from the common subset and each of the specific subsets,
d2) executing the extractor with the mixed dataset, and classifying the resulting sets of features into subsets of sets of features according to the subset from which the image data in the mixed dataset are derived,
d3) executing each classifier with the subset of sets of features corresponding to the subset that has been used in training that classifier in the operation a), b) or c),
d4) calculating for each classifier a loss value from the classification or labelling value originating from the operation d3), and
d5) carrying out a backpropagation from a weighted average of the loss values of the operation d4).

2. The device according to claim 1, wherein the extractor is a deep neural network adapted for the extraction of image features.

3. The device according to claim 2, wherein the extractor is a ResNet-101 deep neural network.

4. The device according to claim 1, wherein the classifiers are ArcFace-type classifiers.

5. The device according to claim 1, comprising a specific subset of human face images having a variety of ages.

6. The device according to claim 1, comprising a specific subset of human face images having a variety of make-ups.

7. A method for training a device for processing human face image data comprising an extractor configured to receive image data and to extract therefrom a set of features, and two or more classifiers configured to receive a set of features from the extractor and to return a classification or labelling value of the corresponding image data, wherein the extractor is a deep neural network and the two or more classifiers comprise a single common neural network and one or more neural networks specific to subsets of human face images, the subsets of human face images comprising at least one common subset of human face images, and one or more specific subsets of human face images such as human face image data of a specific subset of human face images have, individually or together, a common human feature and such that two distinct specific subsets do not have a number of identical images greater than 50%, and the common subset comprising a number of images at least 100 times as great as the numbers of images of the specific subsets,
the method comprising training extractor and the two or more classifiers by the following operations:
a) training the extractor and a first one of the classifiers together using the common subset of human face images,
b) blocking the training of the extractor and by training another classifier with a first specific subset,
c) repeating the operation b) each time with another classifier and with a distinct specific subset, until all distinct specific subsets have been used to train a classifier,
d) carrying out a backpropagation training operation comprising:
d1) defining a mixed dataset comprising image data originating from the common subset and each of the specific subsets,
d2) executing the extractor with the mixed dataset, and classifying the resulting sets of features into subsets of sets of features according to the subset from which the image data in the mixed dataset are derived,
d3) executing each classifier with the subset of sets of features corresponding to the subset that has been used in training that classifier in the operation a), b) or c),
d4) calculating for each classifier a loss value from the classification or labelling value originating from the operation d3), and
d5) carrying out a backpropagation from a weighted average of the loss values of the operation d4).

8. The device according to claim 2, wherein the deep neural network is a ResNet deep neural network, or a DenseNet deep neural network, or a MobileNet deep neural network, or a ResNext deep neural network.
